(19) United States
(12) Patent Application Publication
(10) Pub. No.: US 2009/0208321 A1
(43) Pub. Date: Aug. 20, 2009

(54) TURBINE BLADE TIP CLEARANCE SYSTEM

(76) Inventor: Mark O'LEARY, Zionsville, IN (US)

Correspondence Address: MacMillan, Sobanski & Todd, LLC, One Maritime Plaza, Fifth Floor, 720 Water Street, Toledo, OH, 43604, US

(21) Appl. No.: 12/034,408

(22) Filed: Feb. 20, 2008

(51) Int. Cl. F01D 11/24; F02C 7/12

(52) U.S. Cl. 415/14; 415/115; 415/116

(57) ABSTRACT

A system for adjusting a clearance between blade tips of a turbine and a shroud assembly encircling the turbine in a turbine engine is disclosed herein. The system includes a first fluid passageway operable to extend from a first source of fluid at a variable pressure to a shroud assembly of a turbine engine. The first fluid passageway directs a first stream of fluid to the shroud assembly. The system also includes a first valve positioned along the first fluid passageway and moveable between open and closed configurations. The first valve is biased to the open configuration and moved to the closed configuration passively and directly by a first predetermined level of pressure of the first stream of fluid. During periods of relatively low power production of the turbine engine, the first valve is in the open configuration and moves to the closed configuration when power production of the turbine engine increases from relatively low power production.

### BACKGROUND OF THE INVENTION

1. Field of the Invention

The invention relates generally to gas turbine engines, and more particularly to controlling the radial clearance between a turbine rotor blade tip and a stator shroud assembly.

2. Description of Related Prior Art

In a turbine engine, combustion gases pass across rotatable turbine blades to convert the energy associated with combustion gases into mechanical motion. A shroud assembly tightly encircles the turbine blades to ensure that combustion gases are forced over the turbine blades and do not pass radially around the turbine blades. It is desirable to maintain the smallest possible gap between the tips of the turbine blades and the shroud assembly to maximize the efficiency of the turbine engine. However, a challenge in maintaining the smallest possible gap arises because the turbine blades can expand radially during various phases of engine operation at a rate that is much greater than a rate at which the shroud assembly can radially expand. For example, when the power output of the turbine engine rapidly increases, such as during take-off in a turbine used for aircraft propulsion, the turbine blades will increase in radial length rapidly and the tips of the turbine blades may penetrate the inner linings of the shroud assembly. This could damage both the turbine blades and the shroud assembly. Also, this event can compromise the capacity of the shroud assembly to maintain the smallest possible gap during periods of relatively low power production.

### SUMMARY OF THE INVENTION

In summary, the invention is a system for adjusting a clearance between blade tips of a turbine and a shroud assembly encircling the turbine in a turbine engine. The system includes a first fluid passageway operable to extend from a first source of fluid at a variable pressure, such as some stage of a multi-stage compressor, to a shroud assembly of a turbine engine. The first fluid passageway directs a first stream of fluid to the shroud assembly. The system also includes a first valve positioned along the first fluid passageway. The first valve is moveable between open and closed configurations. The first valve is biased to the open configuration and moved to the closed configuration passively and directly by a first predetermined level of pressure associated with the first stream of fluid. During periods of relatively low power production of the turbine engine, the first valve is in the open configuration and moves to the closed configuration when power production of the turbine engine increases from relatively low power production.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a simplified schematic view of a gas turbine engine according to a first exemplary embodiment of the invention;

FIG. 2 is a first cross-sectional view take along a centerline axis of a second exemplary embodiment of the invention;

FIG. 3 is an exploded view corresponding to the planar view of FIG. 2;

FIG. 4 is a second cross-sectional view take along the centerline axis of the second exemplary embodiment of the invention, taken from an opposite perspective relative to the view of FIG. 2;

FIG. 5 is an exploded view corresponding to the planar view of FIG. 4;

FIG. 6 is a perspective view of a portion of the second exemplary embodiment of the invention showing the positions of fluid passageways relative to one another;

FIG. 7 is a first schematic cross-sectional view of a third exemplary embodiment of the invention;

FIG. 8 is a second schematic cross-sectional view of the third exemplary embodiment;

FIG. 9 is a first schematic cross-sectional view of a fourth exemplary embodiment of the invention; and

FIG. 10 is a second schematic cross-sectional view of the fourth exemplary embodiment.

### DETAILED DESCRIPTION OF EXEMPLARY EMBODIMENTS

A plurality of different embodiments of the invention are shown in the Figures of the application. Similar features are shown in the various embodiments of the invention. Similar features have been numbered with a common reference numeral and have been differentiated by all alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or supplement other embodiments unless otherwise indicated by the drawings or this specification.

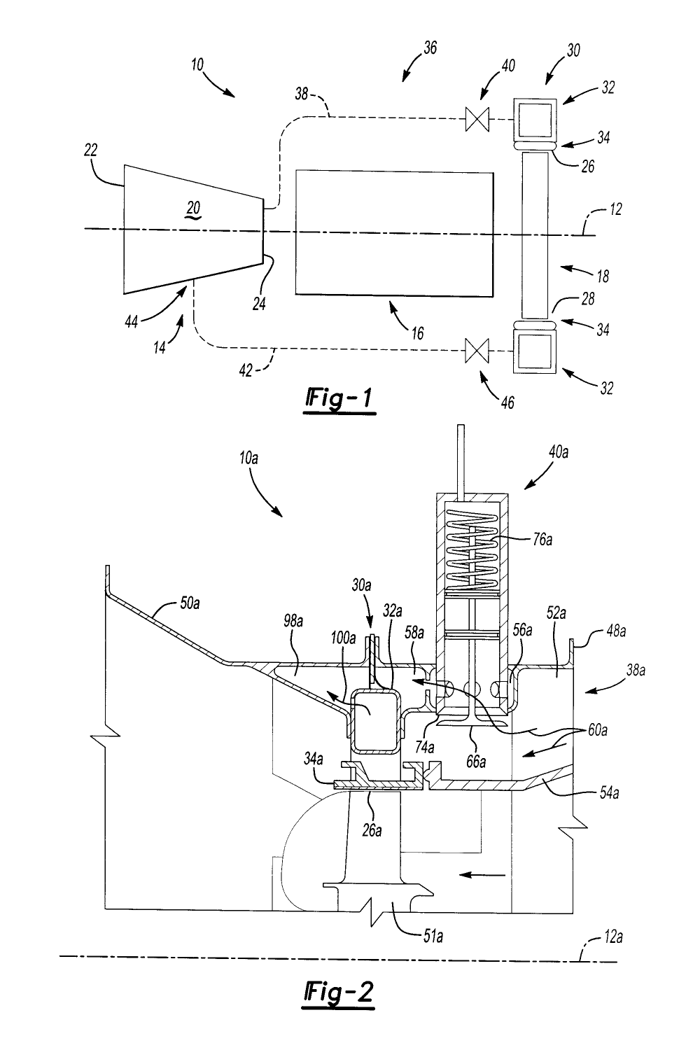

FIG. 1 is a schematic representation of portions of a turbine engine 10 according to a first exemplary embodiment of the invention. The exemplary turbine engine 10 can have a generally annular configuration. However, it is noted that other configurations can be practiced in alternative embodiments of the present invention. It is also noted that the present invention can be practiced in any operating environment, such as aircraft propulsion, industrial applications including but not limited to pumping sets for gas and oil transmission lines, electricity generation, and naval propulsion.

The turbine engine 10 extends along a centerline axis 12 and can include a compressor section 14, a combustor section 16, and a turbine section 18. The compressor section 14 can include a multi-stage compressor 20 having an inlet 22 and an outlet 24. The turbine section 18 can include a plurality of turbine wheels wherein a plurality of turbine blades extend from each turbine wheel. The turbine section 18 is illustrated schematically in FIG. 1, the turbine wheel and turbine blades being shown as single structure for simplicity. Tips of the turbine blades are referenced at 26 and 28 in FIG. 1. The turbine engine 10 can also include a shroud assembly 30 having a hollow ring member 32 and a plurality of blade tracks 34. The ring member 32 can encircle one or more turbine wheels and support the blade tracks 34 in spaced relation to the turbine blade tips 26, 28.

In operation, combustion gases exit the combustor section 16 and pass across the turbine blades of the turbine section 18 to convert the energy associated with the combustion gases into mechanical motion. The shroud assembly 30 can direct the combustion gases over the turbine blades of the turbine section 18. The ring member 32 can circumferentially expand and contract to move the blade tracks 34 and thereby adjust the clearance between the blade tracks 34 and the tips 26, 28. It can be desirable to move the blade tracks 34 to prevent contact with the turbine blade tips 26, 28 because the radial position of the turbine blade tips 26, 28 relative to the centerline axis 12 changes during operation of the turbine engine 10.

The first exemplary embodiment of the invention provides a system 36 for adjusting the radial clearance between the turbine blade tips 26, 28 and the blade tracks 34 of the shroud assembly 30. The system 36 includes a first fluid passageway 38 operable to extend between a source of fluid at a variable pressure to the shroud assembly 30. In the exemplary embodiment of the invention, the source of fluid at variable pressure can be the outlet 24 of the compressor 20. In alternative embodiments of the invention, the source of fluid at variable pressure can be any stage of the compressor 20. The first fluid passageway 38 can extend from the outlet 24 to an interior of the ring member 32. The first fluid passageway 38 is shown schematically in FIG. 1, however, in practice, can be any configuration of conduit, tubing, or piping.

The pressure of the fluid exiting the compressor 20 varies as the power production of the turbine engine 10 varies. For example, when the turbine engine 10 is producing power at a relatively high rate, the pressure of the fluid exiting the outlet 24 will be relatively high. Conversely, when the turbine engine 10 is producing power at a relatively low rate, the pressure of the fluid exiting the outlet 24 will be relatively low.

For a turbine used for aircraft propulsion, as one example, “relatively low power production” occurs just prior to take-off and when the aircraft reaches cruising speed. Power production increases from relatively lower power production rapidly during take-off. Power production may also increase from relatively low power production in response to other conditions.

The fluid exiting the outlet 24 and directed through the first fluid passageway 38 to the interior of the ring member 32 can be relatively hot, even during periods of low power production. Thus, a first stream of fluid directed through the first fluid passageway 38 can heat the ring member 32. Through heating, the ring member 32 can circumferentially expand and move the blade tracks 34 radially outward.

The system 36 can also include a first valve 40 positioned along the first fluid passageway 38. The first valve 40 can be moveable between open and closed configurations and can be biased to the open configuration. The first valve 40 can move to the closed configuration passively and directly in response to a first predetermined level of pressure of the first stream of fluid. As set forth above, when the turbine engine 10 is producing power at a relatively low rate the pressure of the fluid exiting the outlet 24 will be relatively low. The first valve 40 can overcome the pressure of the fluid during periods of relatively low power production and remain in the open configuration. When the turbine engine 10 increases power production from the relatively low rate, the pressure of the fluid exiting the outlet 24 will increase. The first valve 40 can move to the closed configuration passively and directly in response to this increase in fluid pressure. The first valve 40 is shown schematically in FIG. 1. In practice, the first valve 40 can be any configuration of valve, including but not limited to a poppet valve.

The system 36 can also include a second fluid passageway 42 operable to extend between a second source of fluid at a variable pressure to the shroud assembly 30. In the exemplary embodiment of the invention, the second source of fluid at variable pressure can be the an inter-stage portion of the compressor 20. The pressure of the fluid exiting a bleed opening 44 off the inter-stage portion of the compressor 20 varies as the power production of the turbine engine 10 varies. For example, when the turbine engine 10 is producing power at a relatively high rate, the pressure of the fluid exiting the bleed opening 44 will be relatively high. Conversely, when the turbine engine 10 is producing power at a relatively low rate, the pressure of the fluid exiting the bleed 44 will be relatively low. The second fluid passageway 38 can extend from the bleed opening 44 to the interior of the ring member 32. The second fluid passageway 38 is shown schematically in FIG. 1, however, in practice, can be any configuration of conduit, tubing, or piping.

The system 36 can also include a second valve 46 positioned along the second fluid passageway 42. The second valve 46 can be moveable between open and closed configurations and can be biased to the closed configuration. The second valve 46 can move to the open configuration passively and directly by a second predetermined level of pressure of the second stream of fluid. As set forth above, when the turbine engine 10 is producing power at a relatively low rate the pressure of the fluid exiting the bleed opening 44 will be relatively low. The second valve 46 can overcome the pressure of the fluid during periods of relatively low power production and remain in the closed configuration. When the turbine engine 10 increases power production from the relatively low rate, the pressure of the fluid exiting the bleed opening 44 will increase. The second valve 46 can move to the open configuration passively and directly in response to this increase in fluid pressure. The second valve 46 is shown schematically in FIG. 1, however, in practice, can be any configuration of valve, including a poppet valve.

When the second valve 46 is open, the fluid exiting the bleed opening 44 and directed through the second fluid passageway 42 to the interior of the ring member 32 can be relatively cool, even during periods of high power production. Thus, a second stream of fluid directed through the second fluid passageway 42 can cool the ring member 32. Through cooling, the ring member 32 can circumferentially contract and move the blade tracks 34 radially inward. In the first exemplary embodiment of the invention, the temperature of the first stream of fluid exiting the compressor section 20 at low power can be higher than the temperature of the second stream of fluid exiting the bleed opening 44 at high power.

The system 36 can be configured such that the first and second valves 40, 46 act cooperatively. For example, the first and second valves 40, 46 can be designed such that the first valve 40 closes at substantially the same time as the second valve 46 opens. In such an embodiment, when the turbine engine 10 is operating at a relatively low rate of power production, the first valve 40 can be open and relatively hot fluid from the outlet 24 can be received in the interior of the ring member 32. During this period, the relatively cool fluid is not being received from the bleed opening 44 since the fluid is at a relatively low pressure, a level of pressure insufficient to overcome the second valve 46. As a result, the ring member 32 can be heated and circumferentially expanded.

The operation of the turbine engine 10 can then change and power production can be increased. The increased power production will result in the respective pressures of the fluids exiting the outlet 24 and exiting the bleed opening 44 increasing. With respect to the fluid at the outlet 24, the increase in pressure can passively and directly cause the first valve 40 to close and thereby terminate the flow of the first stream of relatively hot fluid to the interior of the ring member 32. With respect to the fluid at the bleed opening 44, the increase in pressure can passively and directly cause the second valve 46 to open and thereby initiate the flow of the second stream of relatively cool fluid to the interior of the ring member 32. As a result, the ring member 32 can be cooled and circumferentially contracted. The first and second valves 40, 46 can be designed such that the second valve 46 opens substantially at the same time as the first valve 40 closes.

It is noted that at any level of power production of the turbine engine 10, the pressure of fluid exiting the outlet 24 will be greater than the pressure of fluid exiting the bleed opening 44. Generally, the pressure at any stage of the compressor 20 will be greater than the pressure at any other upstream stage of the compressor at any particular level of power production. In the exemplary embodiment, the first stream of fluid is directed from the outlet 24 of the compressor 20, however, the first stream of fluid can be drawn from an different, upstream stage of the compressor 20 in alternative embodiments of the invention. In such an embodiment, the second stream of fluid can be drawn from a stage of the compressor 20 upstream of the stage from which the first stream is drawn.

FIG. 1 is a schematic representation of a turbine engine 10 according to the first exemplary embodiment of the invention. FIGS. 2-6 are detailed views showing structures of a second exemplary embodiment of the invention. FIG. 2 shows a portion of a turbine engine 10a, omitting compressor and combustor sections to focus on a shroud assembly 30a. The turbine 10a can be centered on an axis 12a and have a forward housing member 48a and an aft housing member 50a connected together to enclose a turbine blade 51a of a turbine section and the shroud assembly 30a. The shroud assembly 30a can include a ring member 32a and a plurality of blade tracks 34a.

FIG. 2 also shows a portion of a first fluid passageway 38a for directing a first stream of fluid from a source of fluid at variable pressure to the shroud assembly 30a. In the second exemplary embodiment of the invention, the source of fluid can be an outlet of a compressor (not shown). The exemplary passageway 38a can include a first portion 52a defined between the forward housing member 48a and an interior enclosure 54a. The exemplary passageway 38a can also include a second portion 56a downstream of the first portion 52a and defined by the forward housing member 48a. The exemplary passageway 38a can also include a third portion 58a downstream of the second portion 56a and defined between the forward housing member 48a and the ring member 32a. The first stream of fluid can pass through the first fluid passageway 38a as well as the ring member 32a and is represented by arrows 60a.

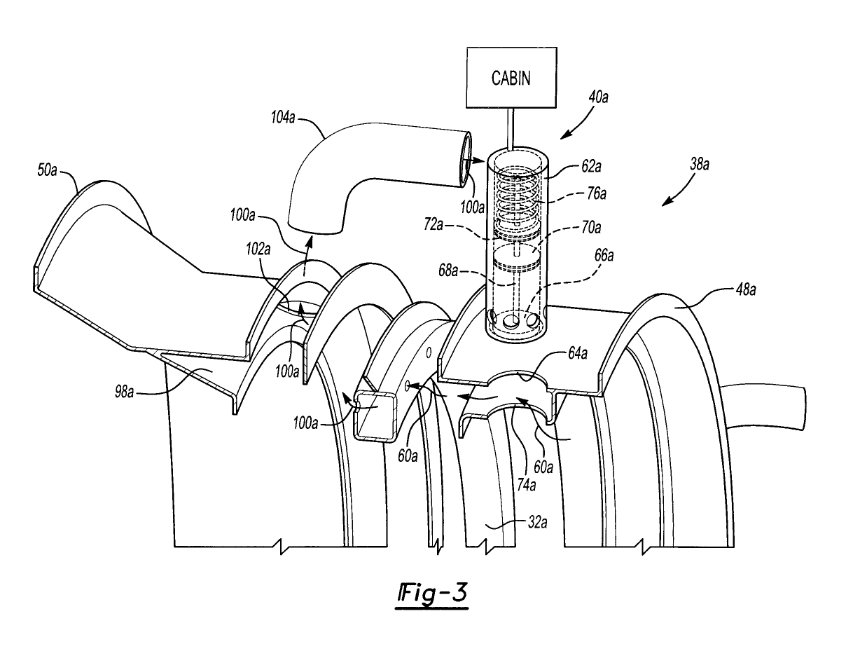

FIG. 2 also shows an exemplary first valve 40a. The first valve 40a can be a poppet valve. FIG. 3 shows that the first valve 40a can include a casing 62a that can bear threads for mating with corresponding threads of an aperture 64a defined by the forward housing member 48a. The first valve 40a can also include a head 66a, a stem 68a, a sealing member 70a, and a disk 72a fixed together and movable within the casing 62a. When the first valve 40a is in the open configuration, the head 66a can be spaced from a valve seat 74a defined by either the casing 62a or the forward housing member 48a. When the first valve 40a is in the closed configuration, the head 66a can be seated on the valve seat 74a. A spring 76a can act directly against the disk 72a to bias the head 66a away from the valve seat 74a. The spring 76a can be disposed in an interior portion of the casing 62a that communicates with cabin air pressure, isolated from the first fluid passageway 38a by the sealing member 70a to prevent the temperature of the first stream of fluid from changing the operating characteristics of the spring 76a. Both of the sealing member 70a and the disk 72a can receive inner o-rings for sealing against the casing 62a.

As shown in FIG. 2, the first valve 40a can be biased to the open configuration. With reference to FIG. 3, the pressure of the first stream of fluid passing through the first fluid passageway 38a can act upon the sealing member 70a. As the pressure of the first stream of fluid increases, the force urging the sealing member 70a against the force of the spring 74a increases. At some predetermined level of pressure, the sealing member 70a can move against the force of the spring 76a until the head 66a seats on the valve seat 74a, closing the valve 40a and terminating the first stream of fluid.

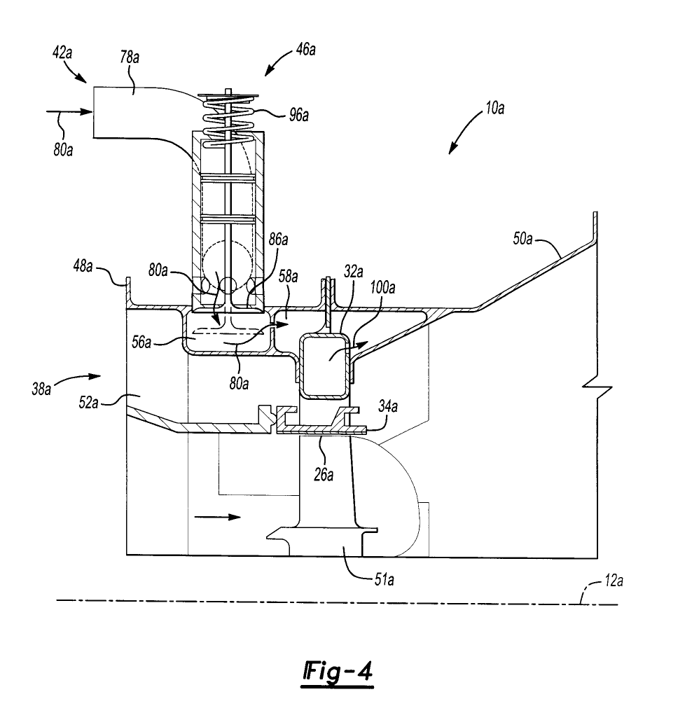

FIG. 4 is a second cross-sectional view of the second exemplary embodiment of the invention taken along the centerline axis 12a. FIG. 4 is taken from a perspective of view that is opposite to the perspective of view taken for FIG. 2. In other words, FIG. 4 can be viewed as centerline cross-section taken from a “right” side of the turbine engine 10a and FIG. 2 can be viewed as centerline cross-section taken from a “left” side of the turbine engine 10a. The designations of “right” and “left” are arbitrary and only used to designate opposite sides.

As shown in FIG. 4, the second exemplary embodiment of the invention includes a second fluid passageway 42a for directing a second stream of fluid from a source of fluid at variable pressure to the shroud assembly 30a. In the second exemplary embodiment of the invention, the second source of fluid at variable pressure can be an inter-stage bleed opening from a compressor (not shown). The exemplary passageway 42a can include a first portion 78a defined by conduit extending along an exterior of the forward housing member 48a. The exemplary passageway 42a can also include the second portion 56a, which is downstream of the first portion 78a and defined by the forward housing member 48a. The exemplary passageway 42a can also include the third portion 58a, which is downstream of the second portion 56a and defined between the forward housing member 48a and the ring member 32a. Thus, the second and third portions 56a and 58a are shared by the first and second fluid passageways 38a, 42a. As a result, the first and second fluid passageways 38a, 42a can partially extend parallel to one another and partially common to one another, the portions 52a and 78a being in parallel and the portions 56a and 58a representing an a common or shared length of passageway. The second stream of fluid can pass through the second fluid passageway 42a as well as the ring member 32a and is represented by arrows 80a.

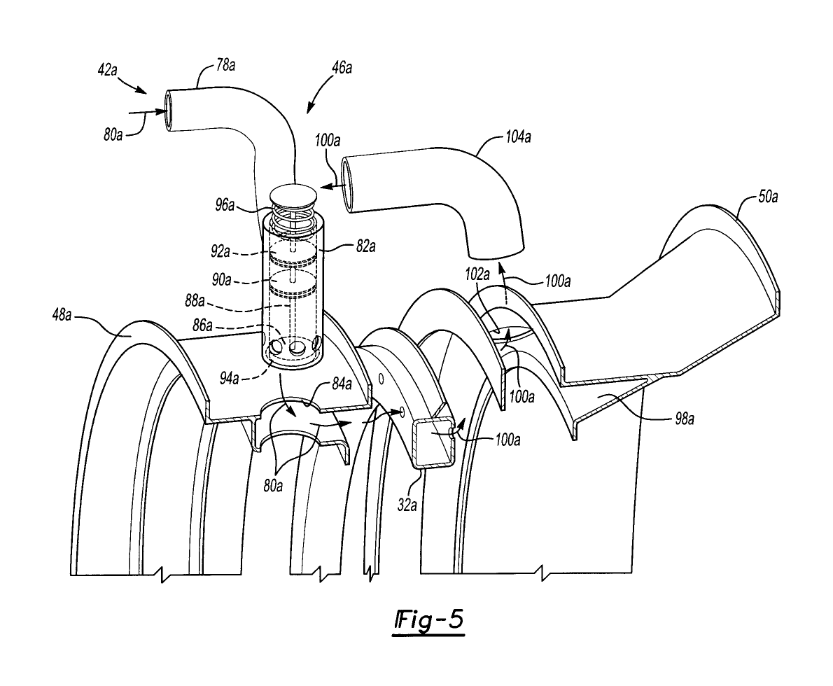

FIG. 4 also shows a second valve 46a. The second valve 46a can be a poppet valve. FIG. 5 shows that the second valve 46a can include a casing 82a that can bear threads for mating with corresponding threads of an aperture 84a defined by the forward housing member 48a. The second valve 46a can also include a head 86a, a stem 88a, a sealing member 90a, and a disk 92a fixed together and movable within the casing 82a. When the second valve 46a is in the open configuration, the head 86a can be spaced from a valve seat 94a defined by either the casing 82a or the forward housing member 48a. When the second valve 46a is in the closed configuration, the head 86a can be seated on the valve seat 94a. A spring 96a can act directly upon the disk 92a to bias the head 86a toward the valve seat 94a, “pulling” the head 86a against the valve seat 94a. The spring 96a can be disposed in an interior portion of the casing 82a that communicates with cabin air pressure, isolated from the second fluid passageway 42a by the sealing member 90a to prevent the temperature of the second stream of fluid from changing the operating characteristics of the spring 96a. The sealing member 90a and disk 92a can receive an o-ring for sealing against the stem 88a.

As shown in FIG. 4, the second valve 46a can be biased to the closed position. The pressure of the second stream of fluid passing through the second fluid passageway 42a acts upon the back of the head 86a. As the pressure of the second stream of fluid increases, the force urging the head 86a to unseat from the valve seat 94a increases. At some predetermined level of pressure, the head 86a can be urged to move against the force of the spring 96a and can unseat from the valve seat 94a, opening the valve 46a and initiating the second stream of fluid.

As with the first embodiment of the invention, the first and second valves 40a, 46a, shown in FIGS. 2 and 4 respectively, can be designed to act cooperatively. For example, the first and second valves 40a, 46a can be designed such that the first valve 40a closes at substantially the same time as the second valve 46a opens. In such an embodiment, when the turbine engine 10a is operating at a relatively low rate of power production, the first valve 40a can be open and relatively hot fluid can be received in the interior of the ring member 32a. During this period, the relatively cool fluid is not being received since second valve 46a is closed. As a result, the ring member 32a can be heated and circumferentially expanded during period of relatively low power production and the gap between a tip 26a of the turbine blade 51a and the blade tracks 34a can be maximized. When the operation of the turbine engine 10 increases from relatively low power production, the resulting increases in the respective fluid pressures of the first and second fluid streams can cause the first valve 40a to close and the second valve 46a to open. During this period, the relatively cool fluid can be received in the ring member 32a and the ring member 32a can therefore be cooled and circumferentially contracted, reducing the size of the gap between the tip 26a of the turbine blade 51a and the blade tracks 34a.

At any level of power production of the turbine engine 10a, the fluid pressure associated with the first fluid stream can be greater than the fluid pressure associated with the second fluid stream. Therefore, the predetermined level of fluid pressure that will cause the first valve 40a shown in FIG. 2 to close can be greater than the predetermined level of fluid pressure that will cause the second valve 46a shown in FIG. 4 to open, if the first and second valves 40a, 46a are designed to act cooperatively as described above.

It is noted that the first and second valves 40a, 46a can be designed such that the respective predetermined levels of pressure are achieved substantially immediately upon acceleration of the turbine engine 10a. In other words, embodiments of the invention can be practiced wherein the first valve 40a is open and the second valve 46a is closed only at the lowest rate of power production or engine speed. In such embodiments, the valves 40a, 46a can be designed such that the first valve 40a closes and the second valve 46a opens substantially immediately upon any acceleration of the turbine engine 10a from idle. However, it also noted that the invention is not limited to such embodiments. The first and second valves 40a, 46a can be tuned differently in alternative embodiments of the invention.

FIGS. 2 and 4 show that in the second exemplary embodiment of the invention, both of the first and second fluid streams act on the first and second valves 40a, 46a. As set forth above, the first fluid stream acts directly on the sealing member 70a of the first valve 40a to close the first valve 40a. The Figures also show that the first fluid stream acts on the second valve 46a as well. For example, the first fluid stream passes through the second portion 56a. The front of the head 86a of the second valve 46a faces the interior of the second portion 56a; therefore, the fluid pressure associated with the first stream cooperates with the spring 96a in urging the second valve 46a closed. The spring rate of the spring 96a can be selected in view of the pressure of the first stream of fluid acting on the front of the head 86a. When the first valve 40a is closed, the fluid pressure associated with the first stream ceases to act on the head 86a of the second valve 46a.

The second fluid stream also passes through the second portion 56a. The back of the head 66a of the first valve 40a faces the interior of the second portion 56a; therefore, the fluid pressure associated with the second stream cooperates with the spring 76a in urging the first valve 40a open. The spring rate of the spring 76a can be selected in view of the pressure of the second stream of fluid acting on the back of the head 66a such that the first valve 40 will not open unless desired.

FIGS. 3 and 5 show that exhaust fluid can exit the ring member 32a and enter a chamber 98a defined by the aft housing member 50a. The exhaust fluid is represented by arrows 100a. The exhaust fluid can be returned to the source of pressurized fluid, such as the inlet of a compressor, to the cabin for an aircraft application, or to cool some other component. The exhaust fluid can pass through an aperture 102a in the aft housing member 50a and into a conduit 104a to reach a desired location.

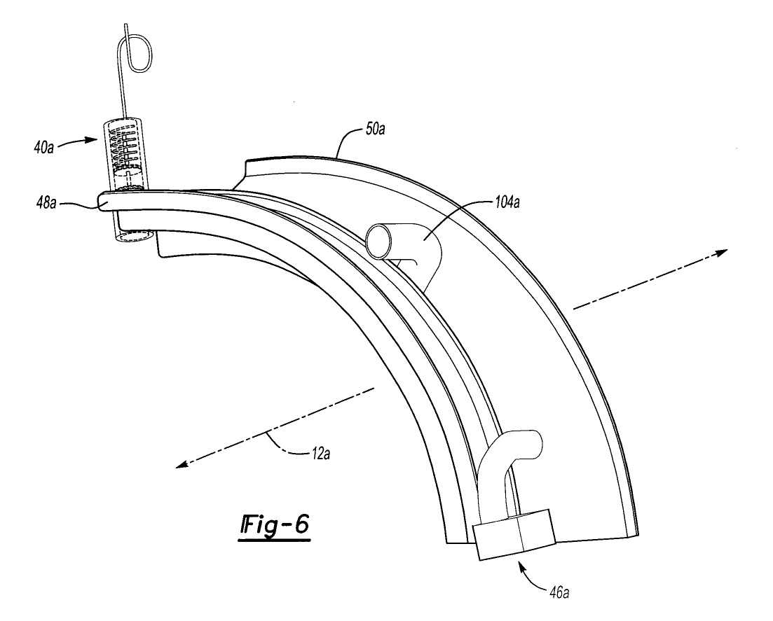

FIG. 6 is a partial perspective view of the second exemplary embodiment of the invention to show an exemplary arrangement of the first and second valves 40a, 46a relative to one another. FIG. 6 only shows about one-quarter of the forward and aft housing members 48a, 50a and only one first valve 40a and one second valve 46a. However, the forward and aft housing members 48a, 50a can fully encircle the centerline axis 12a and the valves 40a, 46a can be positioned along the circle in alternating relation. As a result, the second embodiment can include a plurality of first fluid passageways 38a (shown in FIGS. 2 and 3) and a plurality of second fluid passageways 42a (shown in FIGS. 2 and 3). Conduits 104a for exhaust fluid can be positioned between one of the first valves 40a and one of the second valves 46a.

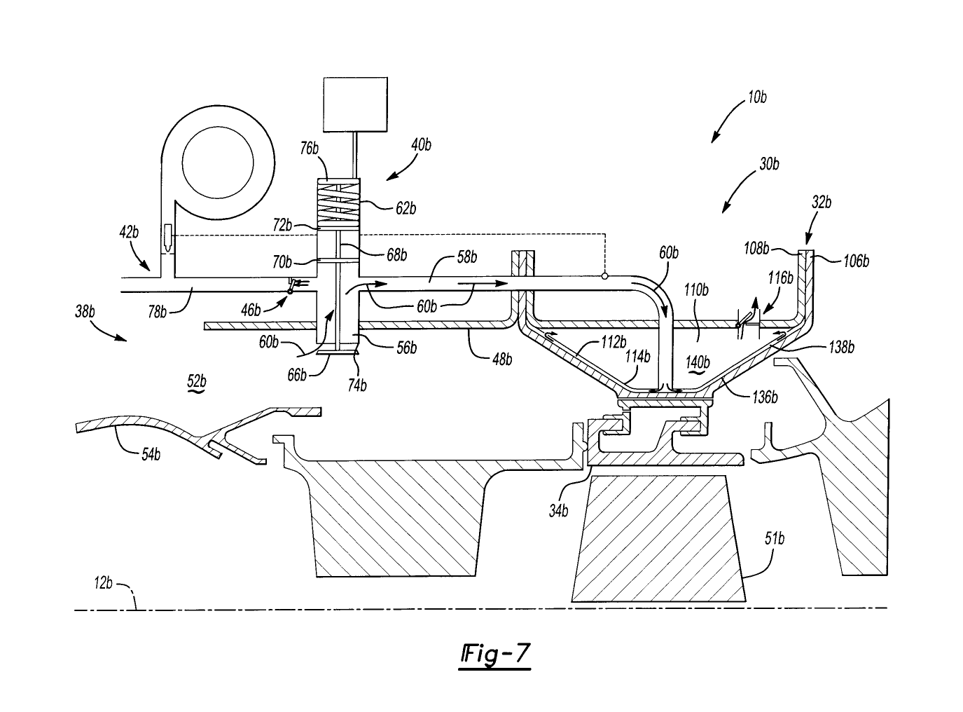

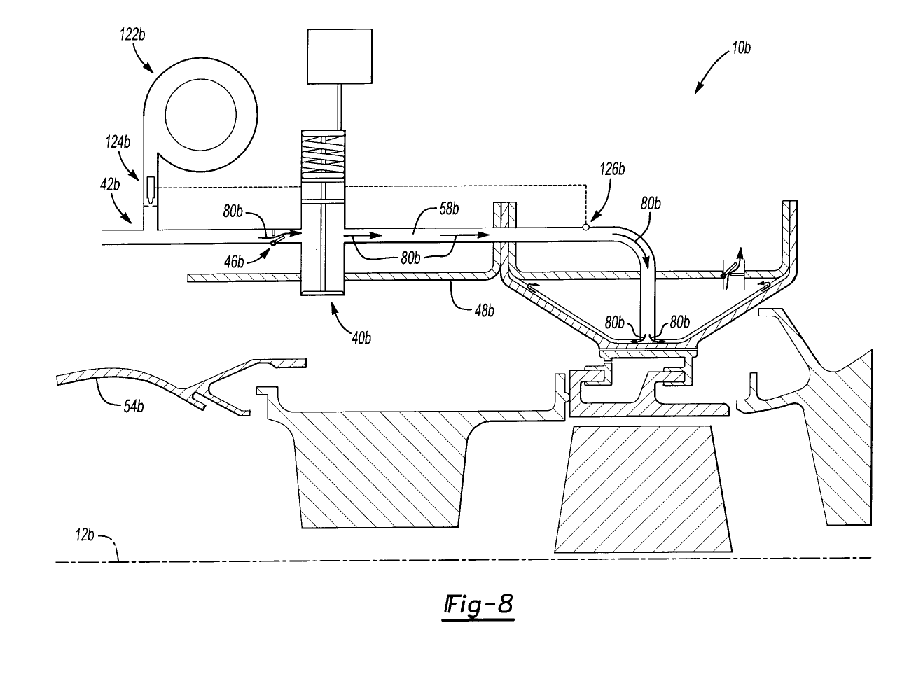

FIG. 7 is a schematic illustration of a third exemplary embodiment of the invention, showing a portion of a turbine engine 10b without showing compressor or combustor sections. The turbine engine 10b can extend along a centerline 12b and can include a forward housing member 48b and a shroud assembly 30b disposed along the axis 12b. The shroud assembly 30b can include ring member 32b and a plurality of blade tracks 34b. The ring member 32b can include an inner member 106b and an outer member 108b. The inner and outer members 106b, 108b can be engaged together to define an annular cavity 110b. The blade track 34b can be spaced radially outward of a turbine blade 51b of the turbine engine 10b.

A first fluid passageway 38b can extend between a source of fluid at a variable pressure to the cavity 110b. The exemplary passageway 38b can include a first portion 52b defined between the forward housing member 48b and an interior enclosure 54b. The exemplary passageway 38b can also include a second portion 56b downstream of the first portion 52b. The second portion 56b can be defined by a first valve 40b (to be described in greater detail below). The exemplary passageway 38b can also include a third portion 58b downstream of the second portion 56b. The exemplary third portion 58b can be a conduit or tubing. The exemplary passageway 38b can also include a fourth portion 112b downstream of the third portion 58b. The fourth portion 112b can communicate directly with the cavity 110b. Fluid can exit the chamber 110b through a one-way check valve 116b. The first stream of fluid is represented by the arrows 60b.

The fourth portion 112b can be defined between the inner member 106b and a plate 114b (illustrated schematically as a single line) The plate 114b can be shaped to correspond to the shape of the inner member 106b and be spaced relatively close to the inner member 106b. The plate 114b can be disposed adjacent to a radially innermost surface 136b in the cavity 110b. The plate 114b can bifurcate the cavity 110b into a first portion 138b defined between the plate 114b and the surface 136b and a second portion 140b. The second portion 140b of the cavity 110b can be larger than the first portion 138b and can be positioned radially outward of the first portion 138b. The first fluid passageway 38b can direct fluid to the first portion 138b to maximize heat transfer between the first stream of fluid and the innermost surface 136b. The plate 114b can focus the flow of fluid to the surface 136b, rather than being dispersed generally in the cavity 110b. As a result, the heat transfer between the fluid and the inner member 106b can be enhanced.

The first valve 40b can be a poppet valve having a casing 62b, a head 66b, a stem 68b, a sealing member 70b, and a disk 72b. The interior of the casing 62b can define the second portion 56b of the fluid passageway 38a. The head 66b, stem 68b, sealing member 70b and disk 72b can be fixed together and movable within the casing 62b. When the first valve 40b is in the open configuration, the head 66b can be spaced from a valve seat 74b defined by either the casing 62b or the forward housing member 48b. When the first valve 40b is in the closed configuration, the head 66b can be seated on the valve seat 74b. A spring 76b can act directly against the disk 72b to bias the head 66b away from the valve seat 74b. The spring 76b can be disposed in an interior portion of the casing 62b that communicates with cabin air pressure, isolated from the first fluid passageway 38b by the sealing member 70b to prevent the temperature of the first stream of fluid from changing the operating characteristics of the spring 76b. The sealing member 70b can be fixed in the casing 62b and receive an o-ring for sealing against the stem 68b.

The third exemplary embodiment can also includes a second fluid passageway 42b and a second valve 46b positioned along the second fluid passageway 42b. The second fluid passageway 42b can include a first portion 78b, as well as the second, third and fourth portions 56b, 58b, 112b. The exemplary second valve 46b can be a one-way check valve. As shown in FIG. 7, the fluid pressure in the first stream of fluid can force the second valve 46b closed.

In FIG. 7, the third exemplary embodiment is shown when power production of the turbine engine 10b is relatively low, such as during idle. The first valve 40b can be open and the second valve 46b can be closed. The first stream of fluid represented by arrows 60b can pass through first fluid passageway 38b to the heat and circumferentially expand the inner member 106b, moving the blade tracks 34b radially outward. FIG. 8 shows the third embodiment of the invention when power production of the turbine engine 10b increases from a relatively low rate. The first valve 40b can be closed and the second valve 46b can be open. The second stream of fluid can pass through second fluid passageway 42b to the cool and circumferentially contract the inner member 106b, moving the blade tracks 34b radially inward. The second stream of fluid is represented by the arrows 80b.

The third exemplary embodiment of the invention also includes a feature not disclosed in the first and second embodiments. As shown in FIG. 8, the turbine engine 10a can include a supplemental cooling system having a pump 122b. The pump 122b can direct fluid at a predetermined temperature to join the second stream of fluid, thereby by decreasing the temperature of the second stream of fluid. This feature can be desirable if the temperature of the second stream of fluid at high power is not as cool as desired. The supplemental cooling system can also include a valve 124b moveable between open and closed positions, a sensor (represented by a point 126b) having a thermocouple or some other structure for identifying temperature change and a controller 125b. The controller 125b can be integral with the valve 124b, the sensor, or be separate from both the valve 124b and the sensor. The sensor can emit a signal to the controller 125b corresponding to a temperature in the third portion 58b. The controller 125b can receive and interpret the signal from the sensor and determine the temperature in the third portion 58b. In response to the determine signal, and in accordance with programmed logic, the controller 125b can control the valve 124b to moved to the open position.

The programmed logic can be carried out such that if the temperature in the third portion 58c is greater than a predetermined value, the controller 125b can cause the valve 124b to open, allowing relatively cool fluid to mix with the second stream of fluid. During periods when the turbine engine 10b is producing relatively low power, the warmer first stream of fluid can be passed by the sensor, causing the valve 124b to move to the open configuration. However, strength of the pump 122b can be selected such that the combined fluid pressure of the second stream of fluid and the fluid from the pump 122b will not urge the valve 46b open during periods when the turbine engine 10b is producing relatively low power. Alternatively, the logic of the controller 125b can be programmed such that the controller 125b is operable to recognize low power operation based on the temperature in the third portion 58c. In other words, the controller 125b can be operable to recognize that when the temperature in the third portion 58c is higher than some predetermined value, the turbine engine is producing power at a relatively low rate and it would not be necessary to direct supplemental cooling fluid to the second fluid passageway 42b.

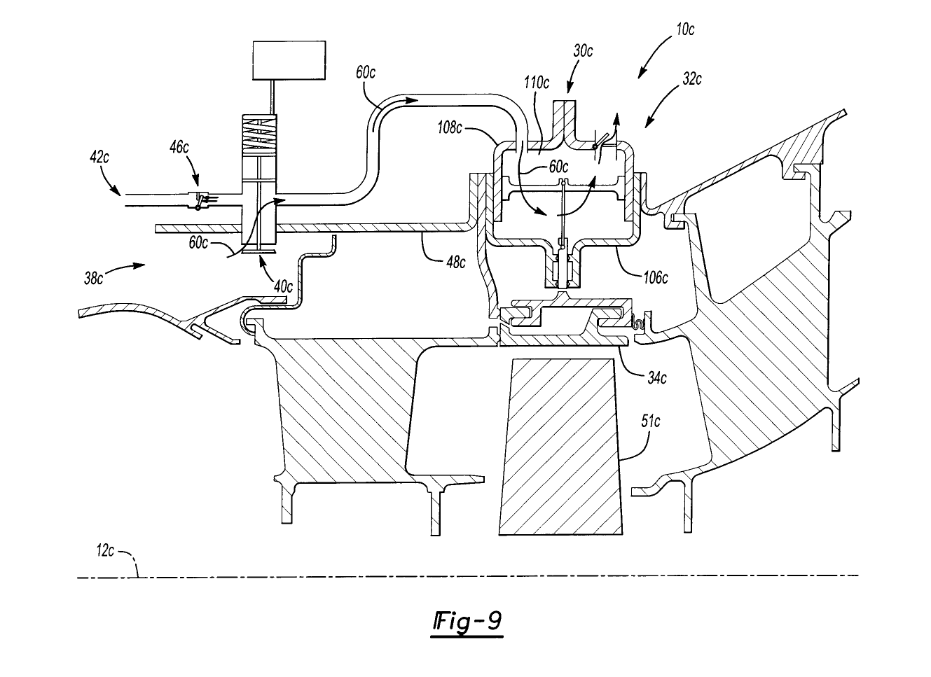

FIG. 9 is a schematic illustration of a fourth exemplary embodiment of the invention. A portion of a turbine engine 10c is shown extending along a centerline 12c. The turbine engine 10c can include a forward housing member 48c and a shroud assembly 30c disposed along the axis 12c. The shroud assembly 30c can include ring member 32c and a plurality of blade tracks 34c. The ring member 32b can include an inner member 106c and an outer member 108c. The inner and outer members 106c, 108c can be engaged together to define an annular cavity 110c. The blade track 34c can be spaced radially outward of a turbine blade 51 c of the turbine engine 10c.

A first fluid passageway 38c can extend between a source of fluid at a variable pressure and the cavity 110c. A first valve 40c can be positioned along the first fluid passageway 38c. A second fluid passageway 42c can extend between a second source of fluid at a variable pressure and the cavity 110c. A second valve 46c can be positioned along the second fluid passageway 42c. The operation of the valves 40c, 46c is generally similar to the operation of the valves of the third exemplary embodiment.

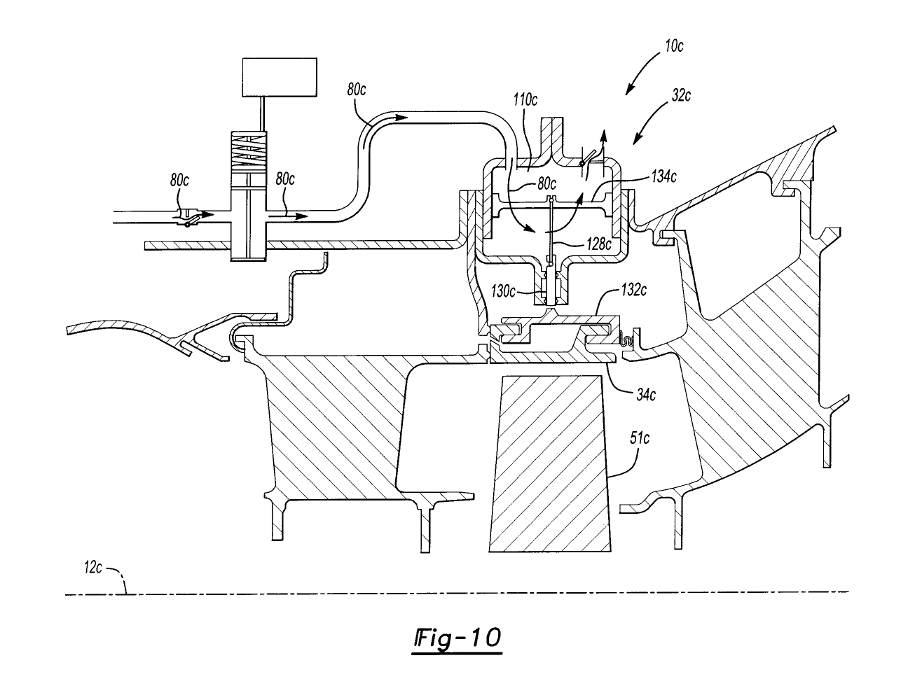

Referring now to FIG. 10, the fourth exemplary embodiment of the invention also includes a feature not disclosed in the first, second or third embodiments. Radial movement of the blade tracks 34c can be accomplished with rods 128c disposed in the cavity 110c. The exemplary rod 128c can be connected to the blade tracks 34c through a linkage, such as exemplary links 130c and 132c. FIG. 10 is a schematic cross-section, showing the connection between the rod 128c and single blade track 34c. A plurality of individual rods 128c can extend 360 degrees around the axis 12c and similar or different linkages can connect each rod 128c to each blade track 34c disposed around the axis 12c.

The rods 128c are coupled to a sleeve member 134c. The sleeve member 134c can extend fully around the axis 12c in the fourth exemplary embodiment of the invention, but could extend only partially around the axis is alternative embodiments of the invention. The sleeve member 134c can be heated by the first stream of fluid (represented by arrows 60c in FIG. 9) and circumferentially expand, pulling the blade tracks 34c radially outward through the linkage defined by the rod 128c and the links 130c and 132c. In addition, sleeve member 134c can be cooled by the second stream of fluid represented by arrows 80c and circumferentially contract, pushing the blade tracks 34c radially inward through the linkage defined by the rod 128c and the links 130c and 132c. The sleeve member 134c can define a plurality of apertures for allowing the passage of heating or cooling fluid around the sleeve member 134c and for increasing the area for heat transfer.

The expansion and contraction of the sleeve member 134c can be guided by the outer member 108c. For example, the sleeve member 134c can be cross-keyed with the outer member 108c such that the sleeve member 134c can move radially relative to the outer member 108c and be prevented from rotating relative to the outer member 108c. At a radially inner periphery, the link 130c can be guided in motion by the ring member 32c or some other structure. Guiding movement of the sleeve member 134c and other portions of the linkage between the sleeve member 134c and the blade track 34c can ensure that expansion and contraction of the sleeve member 134c is effectively transmitted to motion of the blade tracks 34c.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for adjusting a clearance between blade tips of a turbine and a shroud assembly in a turbine engine, the system comprising:
a first fluid passageway in fluid communication with a first source of fluid at a variable pressure and extending to a shroud assembly of a turbine engine to direct a first stream of fluid to the shroud assembly; and
a first valve positioned along said first fluid passageway and moveable between open and closed configurations, said first valve being biased to said open configuration and moved to said closed configuration passively and directly by a first predetermined level of pressure of the first stream of fluid.

2. The system of claim 1 wherein said first valve is further defined as a poppet valve.

3. The system of claim 2 wherein said first valve is further defined as being biased to said open configuration by a spring isolated from the first stream of fluid.

4. The system of claim 1 wherein said first fluid passageway is further defined as being operable to extend between an outlet of a multi-stage compressor and the shroud assembly of the turbine engine.

5. The system of claim 1 further comprising:
a second fluid passageway in fluid communication with a second source of fluid at a variable pressure less than the pressure of the first source of fluid, said second fluid passageway extending to the shroud assembly of the turbine engine to direct a second stream of fluid to the shroud assembly; and
a second valve positioned along said second fluid passageway and moveable between open and closed configurations, said second valve moved to said open configuration passively and directly by a second predetermined level of pressure of the second stream of fluid.

6. The system of claim 5 wherein said second valve is further defined as being biased to said closed configuration.

7. The system of claim 5 wherein said second valve is further defined as a one-way check valve urged to said closed configuration by the first stream of fluid.

8. The system of claim 5 wherein said first and second fluid passageways are further defined as partially parallel to one another and partially common to one another.

9. The system of claim 5 wherein said second fluid passageway is further defined as being operable to extend between a bleed opening at an inter-stage portion of a multi-stage compressor and the shroud assembly of the turbine engine.

10. A method for adjusting a clearance between blade tips of turbine and a shroud assembly spaced radially outward of the blade tips and comprising the steps of:
heating a shroud assembly of a turbine engine with a first stream of fluid directed along a first fluid passageway from an outlet of a compressor section of the turbine engine; and
closing the first fluid passageway to stop said heating step with a first valve positioned along the first fluid passageway, wherein said closing step occurs passively and directly in response to a first predetermined level of pressure of the first stream of fluid.

11. The method of claim 10 wherein said heating step is further defined as occurring only during periods of relatively low power production of the turbine engine.

12. The method of claim 1 1 wherein said closing step is further defined as occurring when power production of the turbine engine increases from a period of relatively low power production.

13. The method of claim 10 further comprising the steps of:
opening a second fluid passageway to direct a second stream of fluid to the shroud assembly from an inter-stage portion of the compressor section to cool the shroud assembly.

14. The method of claim wherein said opening step is further defined as occurring only when power production of the turbine engine increases from relatively low power production.

15. The method of claim 13 wherein said opening step and said closing step are further defined as being concurrent with one another.

16. The method of claim 13 wherein said opening step is further defined as:
opening the second fluid passageway passively and directly in response to a second predetermined level of pressure of the second stream of fluid.

17. The method of claim 13 wherein said opening step is further defined as:
opening the second fluid passageway passively and directly in response to a pressure differential between the first and second streams of fluid.

18. The method of claim 13 further comprising the steps of:
closing the second fluid passageway with a second valve; and
forming the first fluid passageway and the second passageway to be common with one another downstream of the first and second valves to prevent both of the first and second streams of fluid from flowing concurrently to the shroud assembly.

19. A turbine engine comprising:
a multi-stage compressor section;
a turbine section having a plurality of turbine blades spaced from said multi-stage compressor section along a centerline axis;
a shroud assembly supporting a plurality of blade tracks in radially spaced relation to said turbine blades and defining an annular chamber encircling an axis;
a first fluid passageway in fluid communication with an outlet of said multi-stage compressor section and extending to said annular chamber of said shroud assembly to direct a first stream of fluid to said shroud assembly;
a first valve positioned along said first fluid passageway and moveable between open and closed configurations, said first valve being biased to said open configuration and moved to said closed configuration passively and directly by a first predetermined level of pressure of the first stream of fluid.
a second fluid passageway in fluid communication with an inter-stage portion of said multi-stage compressor section and extending to said annular chamber to direct a second stream of fluid to said annular chamber; and
a second valve positioned along said second fluid passageway and moveable between open and closed configurations, said second valve moved to said open configuration passively and directly by a second predetermined level of pressure of the second stream of fluid.

20. The turbine engine of claim 19 wherein said first and second valves are positioned in circumferentially-spaced relation to one another about said centerline axis.

21. The turbine engine of claim 19 further comprising:
a supplemental cooling system communicating with said second fluid passageway to cool the second fluid stream by directing additional fluid to the second fluid stream.

22. The turbine engine of claim 19 wherein said supplement cooling system includes:
a pump;
a third valve positioned between said pump and said second fluid passageway and moveable between open and closed configurations to selectively direct the additional fluid to the second fluid stream;
a sensor positioned along said second fluid passageway and operable to communicate a signal corresponding to a temperature in said second fluid passageway; and
a controller operable to receive the signal from said sensor and control said third valve to move to one of the open and closed configurations.
